(19) United States
(12) Patent Application Publication
(10) Pub. No.: US 2018/0141381 A1
(43) Pub. Date: May 24, 2018

(54) BELT ASSEMBLIES COATED WITH A MAGNETIC RUBBER COMPOSITION AND TIRES INCLUDING THE SAME

(71) Applicant: Bridgestone Americas Tire Operations, LLC, Nashville, TN (US)

(72) Inventors: Emily A. Welles, Aiken, SC (US); Craig R. Balnis, Akron, OH (US); Priyavardhana Srinivasan, Akron, OH (US)

(21) Appl. No.: 15/735,424

(22) PCT Filed: May 3, 2016
(86) PCT No.: PCT/US16/30572

§ 371 Date: Dec. 11, 2017

Related U.S. Application Data
(60) Provisional application No. 62/174,222, filed on Jun. 11, 2015.

(51) Int. Cl. B60C 9/18; B60C 9/00; C08L 7/00; C08L 9/00

(52) U.S. Cl. CPC B60C 9/18; B60C 9/0028; B60C 2001/0066; C08L 9/00; C08L 7/00

(57) ABSTRACT

Disclosed herein are magnetic rubber compositions including magnetic particles and a rubber, and tires and tire components made from the magnetic rubber compositions. The magnetic rubber compositions are used to form belt assemblies having non-metal reinforcing components, such as fiberglass. Also disclosed herein are method of manufacturing belt assemblies and tires with non-metal belt assemblies that incorporate the magnetic rubber compositions.

### TECHNICAL FIELD

The present invention relates to belt assemblies coated with a magnetic rubber composition and tires including the same, and more particularly, fiberglass belts disposed in a magnetic rubber belt skim and tires including the same.

### BACKGROUND

Tires can have a steel belt that imparts stiffness to the tire. Steel-belted tires, commonly called radial tires, have been a standard in the tire industry since the mid-1970s. Belted tires include a belt or belt-like structure arranged under the tread portion at the crown region of the tire carcass. Layers of steel belts can be used to increase rigidity of the tire. For example, the belt may be made of one or more plies of generally inextensible reinforcing steel cords that may be parallel to each other and confined between ply-wide skim coats or layers of rubber. The use of steel belts presents drawbacks, for instance, there is a need to add additional rubber above the belt and at the belt edges in an effort to prevent belt components, such as cords, from becoming exposed or separating from the tire. The use of increased rubber can lead to higher rolling resistance and hysteresis effects. The use of steel also contributes to making the tires heavier.

Non-metal belts and reinforcing components, such as fiberglass belts, can be used to provide a tire having reduced weight and improved rolling resistance. Manufacturing a tire with a non-metal belt can present compatibility problems with conventional tire manufacturing equipment. Metal belts are coated with rubber belt skims and are transferred through a tire manufacturing process with the use of magnets that rely on the presence of the metal belt to securely hold the rubber-coated belt component in place. Replacing steel belts with non-metal materials can make it difficult to utilize magnet-equipped manufacturing equipment.

There remains a need for addressing the drawbacks of steel-belted tires with other non-metal components while also being able to utilize current manufacturing equipment designed with magnets. The belts for tires described herein provide a magnetic belt skim that can be used with magnet-equipped manufacturing equipment for making non-metal belt assemblies.

### SUMMARY

Described herein is a belt or belt assembly for use in a tire, the belt including a reinforcing component. The reinforcing component can be disposed in a belt skim. The belt skin includes a magnetic rubber composition containing rubber and magnetic particles.

The reinforcing component can be a non-metal material, for example, fiberglass or a plurality of non-metal cords. In an embodiment, the belt does not include or is free of a metal or metal cord as a reinforcing component.

The belt is magnetic and the belt skim including the magnetic rubber composition provides the magnetic property to the belt and the one or more non-metal reinforcing components of the belt. In one embodiment, the magnetic belt is a component of a tire, for example, a vehicle tire.

In another embodiment, the belt skim including the magnetic rubber composition can be in direct contact with the belt or reinforcing component. The belt skim can coat the entire surface of the belt or reinforcing component or, alternatively, a portion of the surface of the belt or reinforcing component.

The magnetic rubber composition of the belt skim can include 10 to 100 parts per hundred parts of rubber by weight, phr, of magnetic particles, for example, magnetic nanoparticles or particles having an average particle size of less than 10 microns. The magnetic particles can be ferrite magnetic particles or rear earth magnetic particles.

In one embodiment, the magnetic rubber composition can include a ferrofluid dispersed therein. The ferrofluid dispersed in the magnetic rubber composition can be a ferrofluid that includes magnetic nanoparticles. The magnetic nanoparticles can have a average particle size of less than 10 nanometers. The ferrofluid dispersed in the magnetic rubber composition can include a dispersant and a carrier, wherein the magnetic particles of the ferrofluid are coated with the dispersant.

In another embodiment, a vehicle tire can include a magnetic fiberglass belt component or assembly. The magnetic fiberglass belt component can be coated with or disposed in a belt skim, for example, the belt skim being in direct contact with the fiberglass belt or a portion thereof. The belt skin includes a magnetic rubber composition containing rubber and magnetic particles.

The vehicle tire can be free of magnetic rubber compositions other than the magnetic rubber composition of the belt skim. The belt of the vehicle tire can also not include a metal belt component or metal cord such that the magnetic property of the fiberglass belt is provided by the belt skim including the magnetic rubber composition.

The magnetic rubber composition of the belt skim coating the fiberglass belt can include 10 to 100 parts by weight of magnetic particles, for example, magnetic nanoparticles or particles having an average particle size of less than 10 microns. The magnetic particles can be ferrite magnetic particles or rear earth magnetic particles.

In another embodiment, the magnetic particles of the magnetic rubber composition can be nanoparticles of a ferrofluid, for example, the magnetic particles can be present in the composition by adding a ferrofluid to the magnetic rubber composition and dispersing the ferrofluid throughout the magnetic rubber composition.

### BRIEF DESCRIPTION OF THE DRAWINGS

FIG. 1 shows a cross-section view of a tire incorporating a belt structure coated with a magnetic rubber composition.

FIG. 2 shows a perspective, fragmented view of a tire incorporating a belt structure coated with a magnetic rubber composition.

### DETAILED DESCRIPTION

Herein, when a range such as 5-25 (or 5 to 25) is given, this means preferably at least or more than 5 and, separately and independently, preferably not more than or less than 25. In an example, such a range defines independently at least 5, and separately and independently, not more than 25.

Any reference to the “invention” may refer to one or more, but not necessarily all, of the inventions defined by the claims.

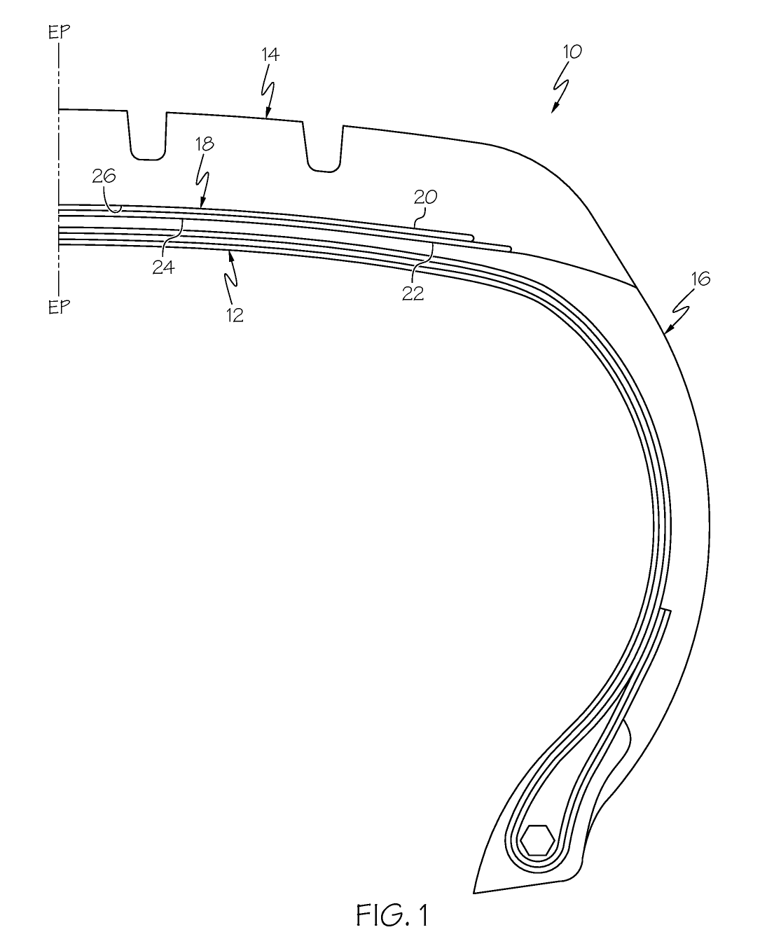

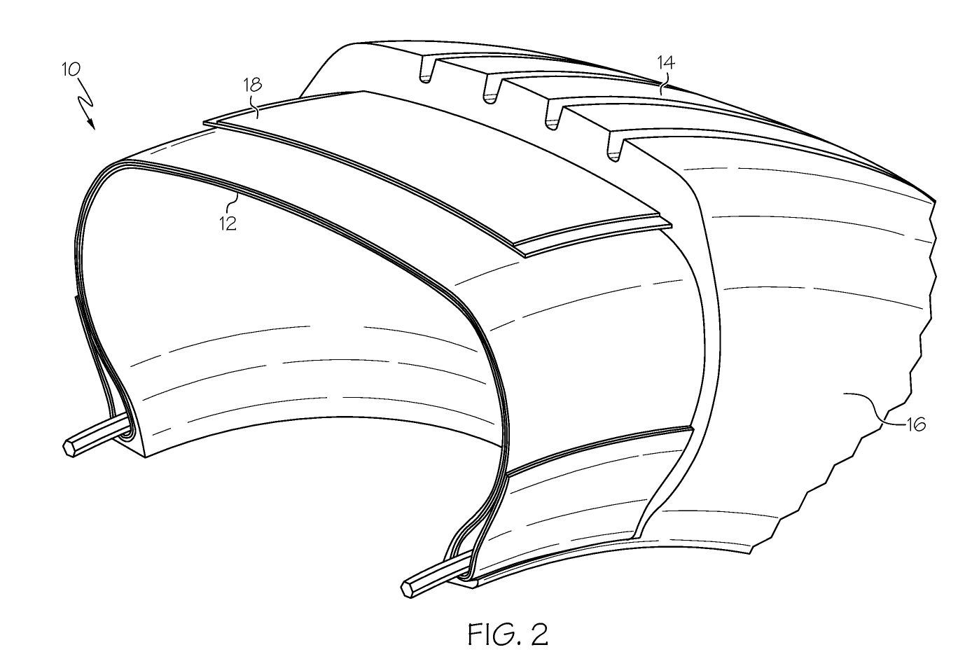

An example of a tire 10 according to the invention is shown in FIGS. 1 and 2. The tire 10 can be a vehicle tire, such as radial passenger or truck tire, and can be constructed in a manner conventional in the art. The tire 10 can also include those used for two-wheeled vehicles (e.g., motorcycles), aircraft, industrial vehicles (e.g., vans), heavy vehicles, buses, road transport machinery (e.g., tractors, trailers), off-road vehicles, agricultural machinery or construction machinery, and other transport or handling vehicles. The tire 10 includes a tire carcass 12, a tread portion 14, a sidewall assembly 16 and a belt structure or assembly 18 arranged between the tread portion 14 and tire carcass 12. As shown in FIG. 1, only half of the tire 10 is depicted with the other half being the same as the depicted half.

The belt assembly 18 is positioned circumferentially about the radial outer surface of the tire carcass 12 and beneath the tread. The belt assembly 18 can provide lateral stiffness across the belt assembly width and reduce lifting of the tread portion 14 from the road surface during rolling. In the embodiment illustrated, the belt assembly 18 can include one or more belt plies 20, 22. The belt plies can include reinforcing components, for example, cords, wires or combination of both made of a non-metal material. In certain embodiments, the reinforcing component may be in different forms, for example, a unitary cord (unit cord), a film (e.g., a strip or band), a multitude of cords that can be twisted together (e.g., a cable) or generally parallel to one another (e.g., a bundle of cords or assembly of fibers).

The reinforcing component, for example cords, can be oriented at any desirable angle with respect to the mid-circumferential center-plane of the tire 10, for instance, in the range of 18 to 26 degrees. In the embodiment that two belt plies are present in the tire, for example, plies 20, 22, the reinforcing components can be oriented in opposite directions from another ply layered above or below. The one or more plies, e.g., 20, 22, can be single cut layers, and preferably do not have folded lateral edges.

The reinforcing component of the belt ply, disposed within the belt skim, can be a non-metal material. For example, the reinforcing component can include fiberglass, aramid, rayon, polyester, PEN, PET, PVA or combinations thereof. In an embodiment

The belt plies 20, 22 can include a belt skim. The belt skim can surround a portion of a reinforcing component surface or the entire reinforcing component such that the reinforcing component or plurality of components is encased in the belt skim. The belt skim can be in direct contact with the reinforcing component and/or multiple reinforcing components. Alternatively, an intermediate layer or other coating can be arranged between the reinforcing component and/or multiple reinforcing components and the belt skim. The belt skim can be a ply-wide layer made of a rubber composition. Belt assemblies are shown in U.S. Pat. No. 5,382,621, which are incorporated herein by reference.

The belt skim includes a magnetic rubber composition. The magnetic rubber composition includes rubber or a rubber mixture, which may also be referred to as a vulcanizable composition. The rubber content of the composition can include 100 phr of rubber, which includes at least one rubber. The total amount of all rubbers is considered to be 100 parts (by weight) and denote 100 phr.

The term “phr” means parts per hundred parts of rubber by weight, and is a measure common in the art wherein components of a composition are measured relative to the total of all of the elastomer (rubber) components. The total phr or parts for all rubber components, whether one, two, three, or more different rubber components are present in a rubber composition are defined as 100 phr. Other non-rubber components are generally proportional to the 100 parts of rubber and the relative amounts may be expressed in phr.

Both synthetic and natural rubber may be employed within the magnetic rubber compositions of the belt skim and magnetic rubber composition. These rubbers, which may also be referred to as elastomers, include, without limitation, natural or synthetic poly(isoprene) with natural polyisoprene being preferred, and elastomeric diene polymers including polybutadiene and copolymers of conjugated diene monomers with at least one monoolefin monomer. Suitable polybutadiene rubber is elastomeric and has a 1,2-vinyl content of about 1 to 3 percent and a cis-1,4 content of about 96 to 98 percent. Other butadiene rubbers, having up to about 12 percent 1,2-content, may also be suitable with appropriate adjustments in the level of other components, and thus, substantially any high vinyl, elastomeric polybutadiene can be employed. The copolymers may be derived from conjugated dienes such as 1,3-butadiene, 2-methyl-1,3-butadiene-(isoprene), 2,3-dimethyl-1,2-butadiene, 1,3-pentadiene, 1,3-hexadiene and the like, as well as mixtures of the foregoing dienes. The preferred conjugated diene is 1,3-butadiene.

Regarding the monoolefinic monomers, there include vinyl aromatic monomers such as styrene, alpha-methyl styrene, vinyl naphthalene, vinyl pyridine and the like as well as mixtures of the foregoing. The copolymers may contain up to 50 percent by weight of the monoolefin based upon total weight of copolymer. The preferred copolymer is a copolymer of a conjugated diene, especially butadiene, and a vinyl aromatic hydrocarbon, especially styrene. Preferably, the rubber compound can comprise up to about 35 percent by weight styrene-butadiene random copolymer, preferably 15 to 25 percent by weight.

The above-described copolymers of conjugated dienes and their method of preparation are well known in the rubber and polymer arts. Many of the polymers and copolymers are commercially available. It is to be understood that practice of the present invention is not to be limited to any particular rubber included hereinabove or excluded.

The rubber polymers used in the magnetic rubber composition can comprise either 100 parts by weight of natural rubber, 100 parts by weight of a synthetic rubber or blends of synthetic rubber or blends of natural and synthetic rubber such as 75 parts by weight of natural rubber and 25 parts by weight of polybutadiene. Polymer type, however is not deemed to be a limitation to the practice of the instant invention.

The magnetic rubber composition of the belt skim also includes magnetic particles that impart a magnetic property to the belt skim and to the belt assembly 18. Magnetic means ferro-, ferri-, para- or superparamagnetic as used herein. Magnetic particles can be interchangeably referred to as magnetic powder herein. The shape of the magnetic particles can be spherical, needle shaped or needle like, plate-like or hexagonal or appear flaky or irregular. The magnetic rubber composition can include 10 to 100 phr, 15 to 80 phr, or 20 to 70 phr of magnetic particles or at least 30 phr, 40 phr or 50 phr of magnetic particles.

The magnetic particles are preferably well dispersed in the magnetic rubber composition, for example, by mixing the magnetic particles with components of the rubber composition. The mixing or stirring conditions may be appropriately selected so as to form a uniform distribution of the magnetic particles in the rubber composition. For example, the rubber compositions according to the invention can be obtained by mixing the rubbers with the magnetic particles and other fillers, such carbon black, rubber auxiliaries or the like in conventional mixers, such as rollers, internal mixers and mixing extruders.

The magnetic particles are preferably pre-magnetized prior to addition to the magnetic rubber composition. Alternatively, the magnetic particles can be magnetized in the magnetic rubber composition of the belt skim prior to curing the tire or coated belt. In an embodiment, the magnetized belt skim having the non-metal reinforcing components disposed therein is manufactured with magnetized equipment, e.g., electro-magnetic equipment, that processes and transfers the belt and/or magnetic belt skim through the equipment with the use of a magnetic field. The magnetic feature of the belt skim exhibits attraction to the magnets in the manufacturing equipment and assists in the manufacturing of tires containing non-metal belts.

The magnetic particles of the rubber composition can include ferrite magnets, rare earth magnets, for example those including samarium or neodymium, iron or ferrite oxides, for example, gamma iron oxide and magnetite, metals or metal alloys, cobalt or chromium dioxide, strontium ferrite, barium ferrite, manganese zinc ferrite, nickel zinc ferrite, copper zinc ferrite, neodymium iron boride or combinations thereof. The magnetic particles can also be a mixed oxide, for example of at least two metals such as iron, cobalt, nickel, tin, zinc, cadmium, manganese, copper, barium, magnesium, lithium or yttrium.

The magnetic particles can have an average particle size in the range of 0.1 to 200, 0.5 to 100 or 1 to 50 microns. The average particle size of the magnetic particles can be less than 10, 5, 2 or 1 micron. In one embodiment, the magnetic particles can be nanoparticles, for example, the average particle size of the magnetic nanoparticles can be in the range of 1 to 100 nanometers (nm), or less than 80, 60, 40, 20 or 10 nm.

The magnetic particles can have a residual induction (Br value) of more than 100 G (Gauss), more than 1,000 G, more than 1,500 G, more than 1,750 G or more than 2,000 G. The magnetic particle can have a coercive force (HcB) of more than 2,000 Oe or more than 3,000 Oe. The magnetic particles can have a compressed density of more than 1.5 g/cm³, more than 2 g/cm³, more than 2.5 g/cm³ or more than 3 g/cm³. The magnetic property of the magnetic rubber composition can be measured by pull force attraction to a magnet, for example, the magnetic rubber composition can exhibit a pull force attraction to a magnet in the range of 100 to 200 lbs of pull force, or at least 150 lbs of pull force when measured using a magnet.

In one embodiment, where the magnetic particles in the rubber composition are present by the addition of a ferrofluid as described below, the ferrofluid can have a residual induction (Br value) in the range of 300 to 1,000 G or 400 to 700 G.

In one embodiment, the magnetic rubber composition can include a ferrofluid dispersed therein. The ferrofluid can be the source of the magnetic particles or a portion thereof in the magnetic rubber composition. The ferrofluid can be a stable suspension of magnetic nanoparticles, for example, superparamagnetic particles such as magnetite, hematite or some other compound containing iron, that becomes magnetized only in the presence of a magnetic field. The ferrofluid can be added and blended into the rubber composition by mixing as known in the art to disperse the contents of the ferrofluid, including the magnetic nanoparticles, evenly throughout the rubber composition to form the magnetic rubber composition of the belt skim coating the reinforcing component.

The ferrofluid can include a dispersant and a carrier in addition to the magnetic particles. The ferrofluid can include 3 to 20 volume percent of magnetic particles, 5 to 30 volume percent of a dispersant and 50 to 92 volume percent of a carrier.

The dispersant, for example a surfactant, can coat the magnetic particles or a portion thereof in the ferrofluid to minimize or prevent the magnetic particles from agglomerating and forming large groupings of magnetic particles. The magnetic nanoparticles have an increased surface area and are attracted to one another and thus the dispersant reduces the ability of the magnetic nanoparticles from agglomerating. The magnetic nanoparticles coated or bonded with the dispersant can be referred to as ligand particles. The dispersant can include surfactants such as oleic acid, tetramethylammonium hydroxide, citric acid, sly lecithin and the like. The carrier can be any suitable material, for example, oils such as mineral oil.

The ferrofluid can be added to the magnetic rubber composition in the range of 10 to 60 phr when the ferrofluid contains 3 to 20 volume percent of magnetic particles. The ferrofluid can have a viscosity in the range of 5 to 25 centipoise (cP). The ferrofluid is preferably added to the rubber to form a magnetic rubber composition having 10 to 100 phr, 15 to 80 phr, or 20 to 70 phr of magnetic particles or at least 30 phr, 40 phr or 50 phr of magnetic nanoparticles.

The magnetic rubber composition can include other ingredients as known in the art as additives customarily included in rubber compositions for manufacturing tires, for example, such as mixing the various constituent rubbers with various commonly used additive materials such as, for example, sulfur, sulfur donors, peroxides, curing aids, such as accelerators, activators and retarders and processing additives, such as oils, resins including adhesive or tackifying resins and plasticizers, fillers, pigments, fatty acid, zinc oxide, waxes, anti-degradants such as antioxidants and anti-ozonants and peptizing agents. As known to those skilled in the art the additives mentioned above are selected and commonly used in conventional amounts. Conventional quantities are e.g. quantities of 0.1 to 200 phr.

In an embodiment, fillers can be present in the magnetic rubber composition in a range to 10 to 140 phr, 20 to 100 phr or at less than 100, 80, 70, 60, 50, 40, 30 or 20 phr. Fillers can include, for example, carbon black or silica. Where the magnetic rubber composition includes a blend of silica and another filler (e.g., carbon black), the composition may include up to 10 phr, 7 phr, and up to 5 phr silica, with the balance of the filler including the other filler material (e.g., carbon black). Carbon black fillers can include all carbon blacks, for example the HAF, ISAF and SAF type are suitable. Other examples of carbon black include of ASTM 300, 600 or 700 grade (e.g., N330, N550). The carbon blacks utilized can be in pelletized form or an unpelletized flocculent mass. Preferably, for more uniform mixing, unpelletized carbon black is preferred. Examples of inorganic fillers can include mineral fillers of the silica (SiO₂) type, such as silicas having a BET surface area of less than 450 m²/g, or in the range of 30 to 400 m²/g.

The magnetic rubber composition can include an adhesive resin, which includes at least one adhesive resin. Multiple adhesive resins can be included in the adhesive resin, such as a mixture of phenolic resins. Adhesive resins can include resorcinol, resorcinolic derivatives, monohydric phenols and derivatives thereof, dihydric phenols and derivatives thereof, polyhydric phenols and derivatives thereof, unmodified phenol novolak resins, modified phenol novolak resin, novolak resins, and mixtures thereof. The adhesive resin or combination of resins can be present in the magnetic rubber composition in a range of 0.5 and 10 phr, 1 and 8 phr or less than 6, 5, 4 or 3 phr.

In another embodiment, the magnetic rubber composition can include an accelerator. Sulfur can be used in a range of 0.5 and 10 phr, 1 and 8 phr or less than 6, 5, 4 or 3 phr, as a primary vulcanization accelerator.

The magnetic rubber composition can include a processing oil in the range of 1 to 50 phr, or less than 30, 25, 20, 15 or 12 phr. Examples of oils include paraffinic oils, aromatic oils, naphthenic oils, vegetable oils other than castor oils, and low PCA oils including MES, TDAE, SRAE, heavy naphthenic oils, and black oils.

In another embodiment, the magnetic rubber composition can include a curative or cure package. A cure package can include, for example, at least one of: a vulcanizing agent; a vulcanizing accelerator; a vulcanizing activator (e.g., zinc oxide, stearic acid, and the like); a vulcanizing inhibitor, and an anti-scorching agent. In certain embodiments, the cure package includes at least one vulcanizing agent, at least one vulcanizing accelerator, at least one vulcanizing activator and optionally a vulcanizing inhibitor and/or an anti-scorching agent. Vulcanizing accelerators and vulcanizing activators act as catalysts for the vulcanization agent. Vulcanizing inhibitors and anti-scorching agents are known in the art and can be selected by one skilled in the art based on the vulcanizate properties desired.

Examples of suitable types of vulcanizing agents for use in the rubber compositions according to certain embodiments of the first-third embodiments, include but are not limited to, sulfur or peroxide-based curing components. Thus, in certain such embodiments, the curative component includes a sulfur-based curative or a peroxide-based curative. Examples of specific suitable sulfur vulcanizing agents include soluble sulfur; sulfur donating curing agents, such as an amine disulfide, polymeric polysulfide, or sulfur olefin adducts; and insoluble polymeric sulfur. Preferably, the sulfur vulcanizing agent is soluble sulfur or a mixture of soluble and insoluble polymeric sulfur. For a general disclosure of suitable vulcanizing agents and other components used in curing, e.g., vulcanizing inhibitor and anti-scorching agents, one can refer to Kirk-Othmer, Encyclopedia of Chemical Technology, 3rd ed., Wiley Interscience, N.Y. 1982, Vol. 20, pp. 365 to 468, particularly Vulcanization Agents and Auxiliary Materials, pp. 390 to 402, or Vulcanization by A. Y. Coran, Encyclopedia of Polymer Science and Engineering, Second Edition (1989 John Wiley & Sons, Inc.), both of which are incorporated herein by reference. Vulcanizing agents can be used alone or in combination. Generally, the vulcanizing agents are used in an amount ranging from 0.1 to 10 phr, including from 1 to 7.5 phr, including from 1 to 5 phr, and preferably from 1 to 3.5 phr.

Vulcanizing accelerators are used to control the time and/or temperature required for vulcanization and to improve properties of the vulcanizate. Examples of suitable vulcanizing accelerators for use in the rubber compositions according to certain embodiments disclosed herein include, but are not limited to, hexamethoxymethylmelamine (HMMM), thiazole vulcanization accelerators, such as 2-mercaptobenzothiazole, 2,2′-dithiobis(benzothiazole) (MBTS), N-cyclohexyl-2-benzothiazole-sulfenamide (CBS), N-tert-butyl-2-benzothiazole-sulfenamide (TBBS), and the like; guanidine vulcanization accelerators, such as diphenyl guanidine (DPG) and the like; thiuram vulcanizing accelerators; carbamate vulcanizing accelerators; and the like. Generally, the amount of the vulcanization accelerator used ranges from 0.1 to 10 phr, preferably 0.5 to 5 phr.

Vulcanizing activators are additives used to support vulcanization. Generally vulcanizing activators include both an inorganic and organic component. Zinc oxide is the most widely used inorganic vulcanization activator. Various organic vulcanization activators are commonly used including stearic acid, palmitic acid, lauric acid, and zinc salts of each of the foregoing. Generally, the amount of vulcanization activator used ranges from 0.1 to 6 phr, preferably 0.5 to 4 phr.

Vulcanization inhibitors are used to control the vulcanization process and generally retard or inhibit vulcanization until the desired time and/or temperature is reached. Common vulcanization inhibitors include, but are not limited to, PVI (cyclohexylthiophthalmide) from Santogard. Generally, the amount of vulcanization inhibitor is 0.1 to 3 phr, preferably 0.5 to 2 phr.

The magnetic rubber composition can include at least one anti-degradants to protect the rubber from oxidative attack. Anti-degradants can include an antioxidant or anti-ozonant, and the magnetic rubber composition can be referred to including an AO package of at least one anti-degradant. Anti-degradants can include, for example, p-phenylenediamines (PPDs), such as N-(1,3-dimethylbutyl)-N′-phenyl-p-phenylenediamine (6PPD), trimethyl-dihydroquinolines (TMQs), phenolics, alkylated diphenylamines (DPAs), aromatic phosphites, and diphenylamine-ketone condensates or combinations thereof. The anti-degradants or combination of anti-degradants can be present in the magnetic rubber composition in a range of 0.5 and 12 phr, 1 and 10 phr or less than 9, 8, 7 or 6 phr.

In one embodiment, the magnetic rubber composition can be free of adhesion promoters generally used for metal belt structures. Metal adhesion promoters are known in the art and can include, for example, metal compound or salt type, in particular cobalt, nickel or lanthanide salts and compounds. The metal salts are employed to improve initial adhesiveness between the coating rubber and the metal reinforcing materials in direct vulcanization adhesion generally used for tires and the like.

The magnetic rubber composition preferably exhibits a stress strain profile similar to the same rubber composition that excludes the magnetic particles and is not magnetic. The stress strain profile can include measuring the modulus, break elongation and tensile strength of a rubber composition sample at aged and unaged sample conditions. In an unaged sample (no thermal treatment over a period of time), the overall stress strain profile, here referred to as the average of 300% modulus, elongation at break percent (E_{b}) and tensile strength of the rubber composition sample, can be measured at 25° C. after the rubber composition is formed. The overall stress strain profile for an unaged magnetic rubber composition can be within 0.1 to 12 percent, 1 to 10 percent or less than 8, 7, 6, 5 or 4 percent of the stress strain profile of an unaged non-magnetic rubber composition, wherein the only difference between the magnetic and non-magnetic rubber composition is the respective presence and non-presence of magnetic particles. A magnetic rubber composition aged for 2 days at 100° C. (thermally aged composition) can have an overall stress strain profile measured at 25° C. within 0.1 to 12 percent, 1 to 10 percent or less than 8, 7, 6, 5.4 or 3 percent of the stress strain profile of an aged non-magnetic rubber composition.

Each test, e.g., modulus, tensile strength, of the stress strain profile of the magnetic rubber composition can be similar to the non-magnetic rubber composition excluding the magnetic particles. For an aged or unaged magnetic rubber composition the 300% modulus can be within 1 to 10 percent, 2 to 8 percent or less than 7, 6 or 5 percent of the 300% modulus of an aged or unaged non-magnetic rubber composition. The elongation at break percent of an aged or unaged magnetic rubber composition can be within 1 to 10 percent, 2 to 8 percent or less than 7, 6 or 5 percent of the elongation at break percent of an aged or unaged non-magnetic rubber composition. The tensile strength of an aged or unaged magnetic rubber composition can be within 1 to 10 percent, 2 to 8 percent or less than 7, 6, 5, 4 or 3 percent of the tensile strength of an aged or unaged non-magnetic rubber composition.

The invention also relates to a method of manufacturing a belt structure for a tire and tires containing one or more magnetized belt plies and the belt structure, as well as other components of the tires of this invention, may be manufactured by employing conventional techniques. For instance, the vulcanizable magnetic rubber compositions of this invention can be fabricated into components and tires by employing conventional rubber shaping, molding, and curing techniques. In one or more embodiments, a green belt assembly is formed by extruding the vulcanizable composition to form a green matrix around a plurality of wires or reinforcing components. These techniques are known in the art as described in U.S. Pat. Nos. 7,201,944 and 5,126,501, which are incorporated herein by reference.

The method of manufacturing and the resulting tires relates to a non-metal or fiberglass reinforcing components in a belt ply having a magnetic belt skim containing a magnetic rubber composition for providing a magnetic coating to the non-metal or fiberglass belt ply. A magnetic rubber composition as described herein is provided as a step for manufacturing a belt structure for a tire. The magnetic rubber composition is compounded by mixing magnetic particles or powder with the rubber component or components along with the other ingredients as understood by use of conventional techniques. For example, by kneading the ingredients together in a Banbury mixer or on a milled roll.

In one embodiment, a ferrofluid can be added to the rubber composition to provide the magnetic particles that can be dispersed in the composition to form a magnetic rubber composition. The ferrofluid can contain a carrier fluid, for example an oil such as mineral oil, that can replace similar ingredients in a rubber composition, such as a belt skim composition. For instance, in a compounding step, carrier or carrier-like ingredients, such as an oil, in a rubber composition can be reduced or eliminated and thereby replaced with the carrier in a ferrofluid that is added to provide magnetic particles (e.g., magnetic nanoparticles) to the magnetic rubber composition.

The magnetic rubber composition is coated onto one or more reinforcing components to form a belt ply for a tire such that the reinforcing components are disposed in the magnetic rubber composition. The magnetic rubber composition coats a portion of the reinforcing components and preferably covers the entire surface area of the reinforcing components. The magnetic rubber composition can be calendared into one or more films or sheets for coating the reinforcing components, for example, the reinforcing components can be positioned between a first magnetic rubber sheet and a second magnetic rubber sheet. The first magnetic rubber sheet or second magnetic rubber sheet can be in direct contact with the reinforcing components. In one embodiment, the belt structure does not contain a metal reinforcing component.

The coated reinforcing components, and particular non-metal reinforcing components, can be processed or transferred with the use of a magnetic field that interacts with the magnetic rubber composition coating the reinforcing components. For example, manufacturing equipment, such as a conveyor belt or rollers, can be equipped with a magnet or device for generating a magnetic field. The magnet or magnetic field can be used to attract the belt structure having a magnetic property provided by the magnetic rubber composition. The coated belt can be held in place with the magnetic equipment and transferred through a manufacturing process, for example, transferred between two machines or through a piece of equipment used in a tire manufacturing process. The magnetic attraction between the belt and the equipment secures or retains the belt in place as it travels along or through moving parts in the equipment. Accordingly, conventional and existing equipment used to manufacture steel belts and steel-belted tires that utilize magnets or devices for generating magnetic fields for attracting the steel belt can be used to process and manufacture tires having non-metal belts coated with the magnetic rubber compositions of the invention.

The belt structure can be further processed as known in the art to produce a tire containing the belt. Tires can be made as discussed in U.S. Pat. Nos. 5,866,171, 5,875,527, 5,931,211, and 5,971,046, which are incorporated herein by reference. The tire can have one, two or three belt plies made of non-metal reinforcing components disposed in a magnetic belt skim. The assembled tire components containing the belt structure can be vulcanized or cured to produce a vehicle tire. In one or more embodiments, vulcanization can be effected by heating the vulcanizable composition within a mold. In one or more embodiments, the composition can be heated at a temperature from about 140° C. to about 180° C.

In order to demonstrate the practice of the present invention, the following examples have been prepared and tested. The examples should not, however, be viewed as limiting the scope of the invention. Numerous variations over these specific examples are possible without departing from the spirit and scope of the presently disclosed embodiments. More specifically, the particular rubbers, fillers, and other ingredients (e.g., curative package ingredients) utilized in the following examples should not be interpreted as limiting since other such ingredients consistent with the disclosure in the Detailed Description can be utilized in substitution. In other words, the particular rubbers, fillers, and other ingredients as well as their amounts and their relative amounts in the following examples should be understood to apply to the more general content of the Detailed Description.

### Example 1

Magnetic Rubber Composition Containing Strontium Ferrite

Three rubber compositions were formulated. One rubber composition was formulated without strontium ferrite and two magnetic rubber compositions were formulated with strontium ferrite particles. The strontium ferrite particles had an average particle size of approximately 1 micron. The residual induction (Br value) of the strontium ferrite particles was 1,900 G, the magnetic flux density was 190 milliTesla (mT) and the coercive force (HcB) was 1,650 Oe.

The strontium ferrite particles were compounded with a 50/50 natural rubber/butadiene rubber mixture. The rubber compositions had formulations as follows in Table 1.

TABLE 1

| Ingredient | Phr | Phr | Phr |
|---|---|---|---|
| Natural rubber | 50 | 50 | 50 |
| Butadiene rubber | 50 | 50 | 50 |
| Carbon black (N330) | 20 | 40 | 40 |
| 50:50Tall Oil:Naphthenic Oil | 8 | 0 | 0 |
| Tall Oil | 0 | 4 | 4 |
| Naphthenic Oil | 15 | 9 | 9 |
| Strontium ferrite | 50 | 30 | 0 |
| Zinc Oxide | 2.5 | 2.5 | 2.5 |
| Stearic Acid | 3 | 3 | 3 |
| AO package | 8 | 3 | 3 |
| Curative package #1 | 3.42 | 3.42 | 3.42 |

The 50 phr and 30 phr strontium ferrite magnetic rubber compositions exhibited a pull force of 150 lbs to a magnet as described above. This confirms that the magnetic rubber compositions can be used as a belt skim for coating non-metal belt materials, such as non-metal reinforcing components (e.g., fiberglass materials), for manufacturing a tire. The non-metal belt structure can exhibit magnetic properties imparted by the magnetized rubber composition and conventional manufacturing equipment generally used to make steel belt structures and equipped with magnets or devices for generating magnetic fields can be utilized to manufacture non-metal belt structures coated with the magnetic belt skim of the invention.

The 30 phr strontium ferrite magnetic rubber composition and the 0 phr strontium ferrite rubber composition (non-magnetic rubber composition) were tested to measure stress strain properties. The measurements for unaged and aged rubber compositions are as follows in Table 2.

TABLE 2

| Sample | Stress Strain | 0 phr SF | 30 phr SF |
|---|---|---|---|
| Unaged | 300% Modulus (MPa) | 5.84 | 5.53 |
| Test Temp: 25° C. | Elongation at Break (%) | 568.66 | 538.96 |
| | Tensile Strength (MPa) | 15.31 | 15.11 |
| Aged: 2 day, 100° C. | 300% Modulus (MPa) | 9.23 | 8.81 |
| Test Temp 25° C. | Elongation at Break (%) | 339.01 | 340.28 |
| | Tensile Strength (MPa) | 10.72 | 10.34 |

As can be seen in Table 2, the addition of 30 phr of strontium resulted in a magnetic rubber composition that exhibits a similar stress strain profile, both aged and unaged, to the same rubber composition having no strontium ferrite added. The unaged magnetic rubber composition had a 300% modulus value within 5.3 percent, an elongation at break % value within 5.2 percent and a tensile strength value within 1.3 percent of the unaged strontium ferrite free rubber composition. The aged magnetic rubber composition had a 300% modulus value within 4.6 percent, an elongation at break % value within −0.4 percent and a tensile strength value within 3.5 percent of the aged strontium ferrite free rubber composition. The use of magnetic particles to formulate a magnetized rubber composition unexpectedly benefits a rubber composition by making it magnetic and simultaneously yields a composition with a comparable compound stress strain profile as the non-magnetic rubber composition. This confirms the magnetic rubber compositions described herein are suitable for use as a belt skim for making non-metal belt assemblies.

### Example 2

Magnetic Rubber Composition Containing a Dispersed Ferrofluid

A rubber composition was formulated with a ferrofluid. The ferrofluid was a colloidal suspension of magnetite nanoparticles having an average particle size of about 10 nanometers (nm). The ferrofluid contained 3 to 15 volume percent of magnetite particles, 6 to 30 volume percent of an oil soluble dispersant and 55 to 91 volume percent of mineral oil as a carrier. The magnetite particles were coated with the dispersant to prevent agglomeration of the particles, for example, in the presence of a magnetic field. The ferrofluid exhibited a saturation magnetization in the range of 44 to 65 mT (440 to 650 G) and had a viscosity in the range of 6 to 12 cP.

The ferrofluid was compounded with natural rubber to form a magnetic rubber composition. The magnetic rubber composition had a formulation as follows in Table 3.

TABLE 3

| Ingredient | Phr |
|---|---|
| Natural rubber | 100 |
| Ferrofluid | 30 |
| Carbon black | 45 |
| Adhesive Resin | 1.9 |
| Zinc oxide | 3.5 |
| Stearic acid | 1.2 |
| 2,2,4-trimethyl-1,2-dihydroquinoline (TMQ) | 1 |
| Curative package #2 | 5.2 |

The magnetic rubber composition having the ferrofluid dispersed therein exhibited a pull force of 150 lbs to a magnet. This confirms that the magnetic rubber composition can be used as a belt skim for non-metal belt materials (e.g., fiberglass materials). The non-metal belt structure can exhibit magnetic properties imparted by the magnetic nanoparticles provided by the ferrofluid in the magnetized rubber composition and conventional manufacturing equipment generally used to make steel belt structures and equipped with magnets or devices for generating magnetic fields can be utilized to manufacture non-metal belt structures coated with the magnetic belt skim of the invention.

The ferrofluid in the magnetic rubber composition provided the processing oil component such that a processing oil was not separately added to the composition in addition to the carrier provided in the ferrofluid. The ferrofluid can be formulated with a desirable carrier oil that would otherwise be added to the rubber composition of the belt skim, e.g. mineral oil.

All references, including but not limited to patents, patent applications, and non-patent literature are hereby incorporated by reference herein in their entirety.

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A belt for a tire comprising a non-metal reinforcing component, the non-metal reinforcing component being disposed in a belt skim, the belt skim being composed of a magnetic rubber composition comprising rubber and magnetic particles.

2. The belt of claim 1, the non-metal reinforcing component being a plurality of non-metal cords.

3. The belt of claim 1, the non-metal reinforcing component being fiberglass.

4. The belt of claim 1, the belt being free of a metal cord.

5. The belt of claim 1, the magnetic rubber composition comprising 10 to 100 phr of magnetic particles.

6. The belt of claim 1, the magnetic particles having an average particle size of less than 10 microns.

7. The belt of claim 1, the magnetic particles being nanoparticles.

8. The belt of claim 1, the magnetic particles being ferrite magnetic particles or rear earth magnetic particles.

9. The belt of claim 1, the magnetic rubber composition comprising a ferrofluid dispersed in the magnetic rubber composition, the ferrofluid comprising the magnetic particles and the magnetic particles being nanoparticles.

10. The belt of claim 9, the ferrofluid comprising a dispersant and a carrier, wherein the magnetic particles are coated with the dispersant.

11. A vehicle tire comprising a magnetic fiberglass belt component, the magnetic fiberglass belt component being coated with a belt skim composed of a magnetic rubber composition comprising magnetic particles.

12. The vehicle tire of claim 11, the magnetic rubber composition comprising 10 to 100 phr of magnetic particles.

13. The vehicle tire of claim 11, the magnetic particles being ferrite magnetic particles or rear earth magnetic particles.

14. The vehicle tire of claim 11, the magnetic particles of the magnetic rubber composition being nanoparticles of a ferrofluid.

15. The vehicle tire of claim 17, the belt skim being in direct contact with the fiberglass belt.
